(19) United States
(12) Patent Application Publication
(10) Pub. No.: US 2005/0170138 A1
(43) Pub. Date: Aug. 4, 2005

(54) Laminated thin film with increased dosage loading and improved physical film properties and method for manufacture

(76) Inventor: Craig J. Berry, Westport, CT (US)

Correspondence Address: PERMAN & GREEN, 425 POST ROAD, FAIRFIELD, CT, 06824, US

(21) Appl. No.: 11/039,266

(22) Filed: Jan. 20, 2005

Related U.S. Application Data
(60) Provisional application No. 60/537,664, filed on Jan. 20, 2004.

(51) Int. Cl. B32B 3/14

(52) U.S. Cl. 428/77

(57) ABSTRACT

This invention also provides laminated thin films with increased active ingredient loading. Also disclosed are films where one or more layers are foamed, contain “bubbles”, or entrain a gas to provide a greatly enhanced solid to gas interface and thereby provide a rate of dissolution that can be modified at will.

This application claims priority from application Ser. No. 60/537,664, filed on Jan. 20, 2004.

### BACKGROUND OF THE INVENTION

1. Field of the Invention

In an article entitled A Hot War For Cool Mouths by Alex Kuczynski appearing in The New York Times Tuesday, Mar. 5, 2002 the explosion of the fresh-breath industry is detailed and the article notes that in the previous 18 months, major mint and gum manufacturers have introduced breath-freshening products and repackaged old ones to refashion the humble breath mint or mouth spray.

2. Brief Description of Related Developments

One category of breath-freshening products is edible thin films. Examples of thin films useful as breath-freshening products are those set forth in U.S. Pat. No. 6,419,903 to Xu et al., dated Jul. 16, 2002 assigned to Colgate Palmolive company and entitled Breathe Freshening Film. This patent discloses a film composition and the use of a film composition comprising a mixture of a hydroxyalkylcellulose of specified viscosity, a water dispersible pregelatized starch and a flavoring agent. The hydroxyalklycellulose is more specifically described as a hydroxyl propyl methyl cellulose and the starch content is limited to from about 5 to about 50 weight percent.

The market for thin edible films has since expanded beyond breath improvement into nutritional products, cosmetic and skin care products and over-the-counter pharmaceuticals. As the uses of thin films expand, it becomes more and more critical to provide films that can deliver significant quantities of active ingredient. This requires higher and higher loadings of the active ingredient, which in many cases causes degradation of the properties of the thin film which make it unsuitable as a delivery vehicle.

The amount of active ingredient that can be contained in a thin film is limited by a number of constraints, primary among those being film thickness, strip size, solubility, brittleness and curling.

Thus, there exists a need in the industry to provide a thin film delivery system with satisfactory stability and shelf-life while at the same time providing a sufficiently high loading of active ingredients.

Plasticizers are commonly used to maintain the flexibility of thin films. There are limitations to the amount of the plasticizer that can be used in the film. When excessive plasticizer is employed, the film looses structural integrity, becomes too flimsy and significantly, becomes sticky such that it tends to adhere to other strips of film in the package forming a block. This is especially true when the strips are stacked in a vial, which is a preferred form of primary packaging.

In addition to the problem of active ingredient loading limitations, films are required to dissolve readily when used. Thick films or films with a composition optimized for shelf-life or active ingredient loading may not dissolve as readily as desired when used.

Thus there exists the need for films constructed in such a manner that active ingredient loadings, shelf life duration and ease of use through quick dissolution are all within useable ranges.

There also exists a need for films whose composition can be readily varied to meet the specific requirements of a desired active ingredient loading and identity, stability and ease of use.

### SUMMARY OF THE INVENTION

This disclosure provides for a film structure and a method for manufacturing this film. The disclosed films solve the problems associated with high loadings of active ingredients by laminating multiple layers of thin films to one another, where the films have physical and/or chemical properties which are modified depending on the function that layer plays in the laminate structure, the desired loading and identity of one of more active ingredients and the desired rate of dissolution when used.

This disclosure provides for the use of multiple layered thin films to increase active loading significantly beyond current single or bi-layer films. In general, there may be any number of layers of film in excess of two. For most application, 3 to 5 layer laminates will provide the expected benefits. This invention also provides laminated films where one or more layers are foamed, contain “bubbles”, or entrain a gas to provide a greatly enhanced solid to gas interface and thereby provide a rate of dissolution that can be modified at will.

### DETAILED DESCRIPTION OF THE PREFERRED EMBODIMENT(S)

The thickness of the multi-layer films can vary widely. It is preferably that the thickness of each layer in the multi-layer film be in the range of from about 0.25 to about 12 mils, preferably from about 0.5 to about 2 mils.

There are a variety of film formers that can be used in thin films or strips. Generally, these film formulations include the addition of a plasticizer to prevent the film from becoming too brittle and cracking or otherwise degrading during storage and handling.

For example, one preferred embodiment contains a bottom layer with high plasticizer content, a middle layer with a high active loading and a top layer with high plasticizer content. The resulting film lamination or sandwich remains flat and flexible even if the middle layer became brittle.

Where multiple active ingredients are desired, each may reside in its own laminate layer having different physical or chemical properties. Where two active ingredients are inter-reactive, the separate layers will significantly extend the shelf life of the product or even allow the development of new products by preventing interaction until utilized by the customer or patient.

A further embodiment anticipates that one or more of layers of the laminate layers may also contain gas, typically air, bubbles that increase surface area for improved dissolution. The bubbles would be incorporated into the slurry prior to coating using an in-line mixer and filtered compressed air. The improved dissolution is an important benefit to a thicker film that would otherwise have a reduced rate of dissolution. The foam produced may be open or closed celled. Typically the bubbles will have a diameter on the order of 1 mil.

Multi-layer films can used to dose thin films with high active levels. With current mono-layer films it is possible to achieve maximum loadings in the range of 25 mg. To be truly useful for many applications, loadings as high as 81 mg are required. This is unachievable in a single layer thin film but is possible in a multi-layer film which for example might be used to deliver an 81 mg dose of aspirin.

In a further embodiment that one or more of these layers may also contain bubbles that increase surface area for improved dissolution. In one embodiment of the invention one of the laminate layers acts as a substrate and provides structural integrity, allowing an additional one or more layers to contain one or more active ingredients. Furthermore, by providing structural integrity this layer permits the use of structurally fragile layers in the remaining layers of the laminate. One or more of the structurally fragile layers may be a layer in a foamed form containing additional ingredients that are desired to become immediately available to the user.

Thus a laminate containing a structurally tough film layer may contain one or more layers of a foamed shaving cream or soap or detergent or other cleansing or emollient ingredient which are too fragile to be self supporting. The structurally fragile layer may be other than a foamed layer, such as a layer where the loading of active is too high to provide a desired level of structural integrity.

Where one or more layers is a foamed layer, the foamed layer may be covered on one or both sides, i.e. it may be an inside or outside layer. Where the foamed or fragile layer is sensitive to air or to dehydration when exposed to air, it may be covered on both sides by less sensitive layers.

These films can be manufactured individually and the multiple layers combined after manufacture. In a preferred embodiment the films are manufactured simultaneously. The simultaneous manufacturing process requires the selection of thin films that have the correct rheology so that they don't merge into one another during the manufacturing process.

Exemplary coating methods are a slot die for up to 3 layers of film slurries that have a viscosity range of approximately 15 Cp to 20,000 Cp, or a slide coater for up to 18 layers of film slurries with a viscosity range of approximately 1 Cp to 500 Cp. In a preferred embodiment of the invention the viscosity range for slot die manufacturing procedures is from about 1000 Cp to about 80,000 Cp, most preferably from about 2,000 Cp to about 30,000 Cp. In a preferred embodiment of the invention the viscosity range for slide coater manufacturing procedures is from about 10 Cp to about 300 Cp, most preferably from about 50 Cp to about 200 Cp.

Other coating methods could be used with coating layers that are not coterminious.

In order to form a film layer, the resulting aqueous solution of the film former is defoamed, cast on a carrier (for example, a drum, steel belt, polytetrafluoroethylene-impregnated glass fabric, or plastic or paper film or sheet) to a predetermined thickness, and dried from the carrier side or top and bottom, as by electrical or gas heating, hot air or infrared radiation, so that the water content of the film layer is not greater than 25% by weight and preferably not greater than 20% by weight. Preferably the water content of the film is in the range of about 4 to 15%. The film layer so formed can be continuously wound in roll form without suffering any appreciable blocking.

The films may be prepared by knife-over-roll coat and reverse roll coat as well. Also, it is possible to coat one layer and laminate one or more layers during the coating process, or after the film exits from the oven using in-line lamination.

When the film layer is dried, substantially the entire amount the film former remains in the film layer without undergoing any appreciable evaporation.

In order to form a additional film layers on the film layer obtained in the above-described manner, the film layer may be coated with an solution of a second film former, as by spraying, brushing or transfer from a rotating rubber roller, or dipped in a solution of a second film former after which the coated or dipped film layer is dried.

Alternatively, a film layer may be formed separately and bonded to the film layer by means of water, an adhesive (such as starch) or heat. When the second film layer is formed on the film layer by coating or dipping, the concentration of the solution of film former is generally be in the range of about 1 to 5% by weight. When the film layer is formed separately, the same procedure as described for the film layer can be followed. In this case, the concentration of the aqueous solution of film former may be in the range of about 5 to 20% by weight.

In general, from about 0 to about 50 percent plasticizer may be present in each coating layer, preferably from about 0 to about 30 percent, most preferably between 20 and 30 percent by weight.

1. A laminated thin film comprising at least three layers where at least one layer contains a foam.

2. The laminated thin film of claim 1 where the foam is dried.

3. The laminated thin film of claim 1 where the foam is open celled.

4. The laminated thin film of claim 1 where at least two layers contain active ingredients.

5. The laminated thin film of claim 4 where the active ingredients are different in different layers.

6. The laminated thin film of claim 1 where the cells of the foam are about 1 mil in diameter.

7. The laminated thin film of claim 1 where at least one layer provides structural integrity to the film and where at least one layer is too structurally fragile to exist as a film in the absence of the structurally integral film layer.

8. The laminated thin film of claim 1 where the thickness of each layer in the multi-layer film be in the range of from about 0.25 to about 12 mils.

9. The laminated thin film of claim 1 where the thickness of each layer in the multi-layer film be in the range of from about 0.5 to about 2 mils
